(19) United States
(12) Patent Application Publication
(10) Pub. No.: US 2018/0243779 A1
(43) Pub. Date: Aug. 30, 2018

(54) MICRO-POSITIVE PRESSURE HUB POWDER SPRAYING TURNTABLE

(71) Applicant: CITIC Dicastal CO.,LTD., Qinhuangdao (CN)

(72) Inventors: Zhiwei Qin, Qinhuangdao (CN); Hongtao Wang, Qinhuangdao (CN); Jinbao Su, Qinhuangdao (CN); Huanming Ma, Qinhuangdao (CN); Qingwang Wei, Qinhuangdao (CN); Lei Liu, Qinhuangdao (CN); Bo Ning, Qinhuangdao (CN)

(21) Appl. No.: 15/609,662

(22) Filed: May 31, 2017

(30) Foreign Application Priority Data
Feb. 25, 2017 (CN) 201710105128.8

(51) Int. Cl. B05B 15/00; F16J 15/54; B05B 7/14

(52) U.S. Cl. CPC B05B 15/001; B05B 7/14; F16J 15/54

(57) ABSTRACT

Disclosed is a micro-positive pressure hub powder spraying turntable, comprising a base, a revolution motor, a cantilever, braces, autorotation motors and auxiliary equipment, wherein the base is located below the cantilever and configured as a closed cavity structure, in which are provided the revolution motor and a decelerator connected with the revolution motor, output shaft of the decelerator is revolution main shaft of the cantilever, a central hole is formed in the main shaft, the cantilever is also configured as a closed cavity structure, and autorotation motor sealing cavities are formed at the two ends of the cantilever; cavity of the base, central hole of the revolution main shaft, cavity of the cantilever and autorotation motor sealing cavities are communicated with one another to form an overall micro-positive pressure cavity; an external compressed air pipe penetrates through side wall of the base and is connected with the micro-positive pressure cavity.

### CROSS-REFERENCE TO RELATED APPLICATIONS

This application is filed based upon and claims priority to Chinese Patent Application No. 201710105128.8, filed on Feb. 25, 2017, the entire contents of which are incorporated herein by reference.

### TECHNICAL FIELD

The disclosure relates to a micro-positive pressure hub powder spraying turntable, and specifically belongs to the field of hub spraying equipment.

### BACKGROUND

In an off-line powder spraying line, a hub conveyed by a ground chain is needed to be grabbed by a robot and put onto a rotary workbench brace, and the hub is transferred to a powder room for spraying powder by rotation of a turntable. The working environment of the turntable is quite severe, and powder coatings are extremely easy to enter the inner cavity of the turntable, leading to mechanical failure of the turntable, thus influencing normal use.

### SUMMARY

Aiming at the above shortcomings of the prior art, the disclosure provides a micro-positive pressure hub powder spraying turntable capable of avoiding mechanical failure caused by dust entering the inner cavity of the turntable.

The technical solution for solving the technical problems adopted in the disclosure is that a micro-positive pressure hub powder spraying turntable includes a base, a revolution motor, a cantilever, braces, autorotation motors and auxiliary equipment.

The base is located below the cantilever and configured as a closed cavity structure, in which are provided the revolution motor and a decelerator connected with the revolution motor, the output shaft of the decelerator is the revolution main shaft of the cantilever, a central hole is formed in the main shaft, the cantilever is also configured as a closed cavity structure, and autorotation motor sealing cavities are formed at the two ends of the cantilever; the cavity of the base, the central hole of the revolution main shaft, the cavity of the cantilever and the autorotation motor sealing cavities are communicated with one another to form an overall micro-positive pressure cavity; and an external compressed air pipe penetrates through the side wall of the base and is connected with the micro-positive pressure cavity.

Further, the compressed air pipe penetrates through the side wall of the base, sequentially penetrates through the central hole of the revolution main shaft and the cavity of the cantilever and is connected to the autorotation motor sealing cavities, and compressed air charged to the autorotation motors can only flow out of a pipe inlet, so that dust is prevented from entering from the unique outward opening.

Further, the compressed air pipe penetrates through the side wall of the base and is connected to the lower end of the central hole of the main shaft, and compressed air charged to the central hole of the main shaft can only flow out of a pipe inlet, so that dust is prevented from entering from the unique outward opening.

Further, the compressed air pipe is directly connected to the side wall of the base, and charged compressed air can only flow out of a pipe inlet, so that dust is prevented from entering from the unique outward opening.

Further, all the motors are configured with a temperature thermocouple for monitoring the operating temperature thereof and giving an overtemperature alarm.

Further, an autorotation motor is arranged in each autorotation motor sealing cavity, the main shaft of the autorotation motor is upward and a brace is installed on the main shaft.

Further, a thrust bearing is arranged between the base and the cantilever, and the bearing is concentric with the revolution main shaft.

Further, the cleanliness of the adopted compressed air must meet the work requirement of a powder room.

The disclosure has the advantages: micro-positive pressure is formed in the inner cavity of the whole off-line powder spraying turntable by charging clean compressed air, thereby preventing a dust coating from entering the turntable, avoiding mechanical failure caused by dust, prolonging the service life of the turntable and greatly reducing the failure rate of the turntable.

### BRIEF DESCRIPTION OF THE DRAWINGS

FIG. 1 is a top view of an embodiment of the disclosure.

FIG. 2 is a side view of an embodiment of the disclosure.

FIG. 3 is a partial A amplified view of FIG. 2.

### LIST OF REFERENCE SYMBOLS

1 brace
2 autorotation motor
3 autorotation motor sealing cavity
4 cantilever
5 thrust bearing
6 decelerator
7 compressed air pipe
8 base
9 revolution motor
10 positioning shifting fork
11 in-place electronic eye
12 revolution main shaft
13 central hole
14 lower bearing seat
15 upper bearing seat

### DETAILED DESCRIPTION

The disclosure will be further described in detail below in combination with embodiments and the accompanying drawings.

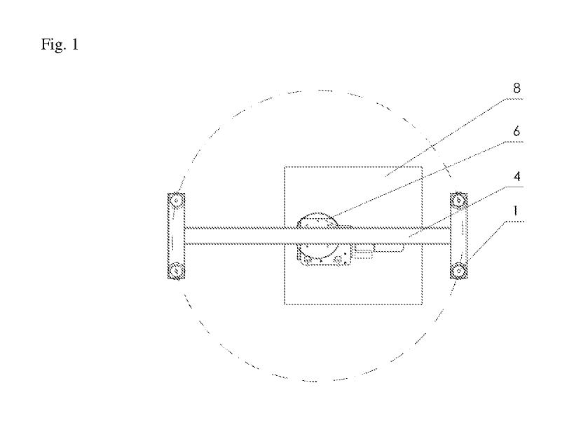

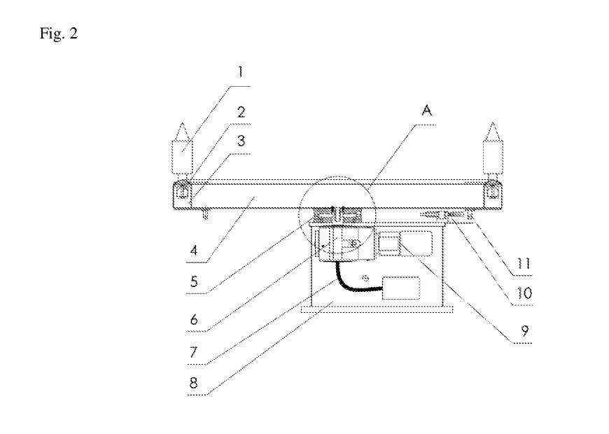

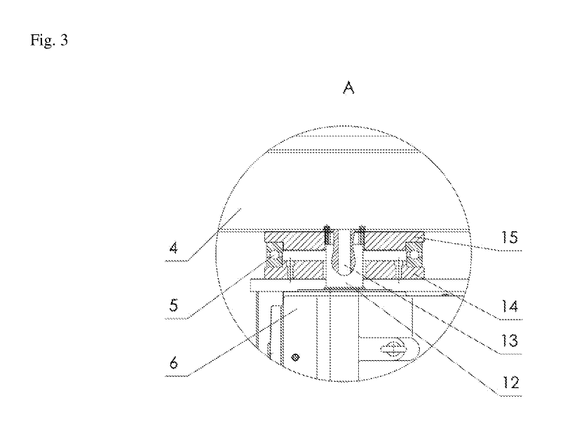

As shown in FIGS. 1, 2 and 3, a micro-positive pressure hub powder spraying turntable includes a base 8, a revolution motor 9, a cantilever 4, braces 1, autorotation motors 2 and auxiliary equipment, in which the base 8 is located below the cantilever 4 and configured as a closed cavity structure, in which are provided the revolution motor 9 and a decelerator 6 connected with the revolution motor, the output shaft of the decelerator 6 is the revolution main shaft 12 of the cantilever, a central hole 13 is formed in the main shaft, the cantilever 4 is also configured as a closed cavity structure, and autorotation motor sealing cavities 3 are formed at the two ends of the cantilever 4; the cavity of the base, the central hole 13 of the revolution main shaft, the cavity of the cantilever and the autorotation motor sealing cavities 3 are communicated with one another to form an overall micro-positive pressure cavity; and a compressed air pipe 7 penetrates through the side wall of the base 8 and is connected to the lower end of the central hole 13 of the main shaft.

All the motors are configured with a temperature thermocouple for monitoring the operating temperature thereof and giving an overtemperature alarm.

An autorotation motor 2 is arranged in each autorotation motor sealing cavity 3, the main shaft of the autorotation motor 2 is upward and a brace 1 is installed on the main shaft.

A thrust bearing 5 is arranged between the base 8 and the cantilever 4, and the bearing is concentric with the revolution main shaft 12.

The cleanliness of the adopted compressed air must meet the work requirement of a powder room.

1. A micro-positive pressure hub powder spraying turntable, comprising a base, a revolution motor, a cantilever, braces, autorotation motors and auxiliary equipment, wherein the base is located below the cantilever and configured as a closed cavity structure, in which are provided the revolution motor and a decelerator connected with the revolution motor, the output shaft of the decelerator being the revolution main shaft of the cantilever, a central hole being formed in the main shaft, the cantilever being also configured as a closed cavity structure, and autorotation motor sealing cavities being formed at the two ends of the cantilever; the cavity of the base, the central hole of the revolution main shaft, the cavity of the cantilever and the autorotation motor sealing cavities being communicated with one another to form an overall micro-positive pressure cavity; and an external compressed air pipe penetrating through the side wall of the base and being connected with the micro-positive pressure cavity.

2. The micro-positive pressure hub powder spraying turntable according to claim 1, wherein the compressed air pipe penetrates through the side wall of the base, sequentially penetrates through the central hole of the revolution main shaft and the cavity of the cantilever and is connected to the autorotation motor sealing cavities.

3. The micro-positive pressure hub powder spraying turntable according to claim 1, wherein the compressed air pipe penetrates through the side wall of the base and is connected to the lower end of the central hole of the main shaft.

4. The micro-positive pressure hub powder spraying turntable according to claim 1, wherein the compressed air pipe is directly connected to the side wall of the base.

5. The micro-positive pressure hub powder spraying turntable according to claim 1, wherein all the motors are configured with a temperature thermocouple.

6. The micro-positive pressure hub powder spraying turntable according to claim 1, wherein an autorotation motor is arranged in each autorotation motor sealing cavity, the main shaft of the autorotation motor is upward and a brace is installed on the main shaft.

7. The micro-positive pressure hub powder spraying turntable according to claim 1, wherein a thrust bearing is arranged between the base and the cantilever, and the bearing is concentric with the revolution main shaft.
